(19) United States
(12) Patent Application Publication
(10) Pub. No.: US 2014/0233341 A1
(43) Pub. Date: Aug. 21, 2014

(54) PORTABLE MIXING DEVICE FOR CEMENTITIOUS GROUT

(71) Applicant: Jeff Konczak, Alpena, MI (US)

(72) Inventor: Jeff Konczak, Alpena, MI (US)

(21) Appl. No.: 14/184,246

(22) Filed: Feb. 19, 2014

Related U.S. Application Data
(60) Provisional application No. 61/766,524, filed on Feb. 19, 2013.

(51) Int. Cl. B28C 5/08; B28C 5/00

(52) U.S. Cl. CPC B28C 5/0893; B28C 5/006
USPC 366/8; 366/64

(57) ABSTRACT

A portable mixing device for cementitious grout includes a base portion and a transport mechanism secured to the base portion. The base portion includes a container disposed thereon for receiving a quantity of water and a quantity of dry cementitious grout mixture. The container is in communication with an agitating device for mixing the quantity of water and the quantity of dry cementitious grout mixture to form a cementitious grout mixture. The base portion includes a source of power disposed thereon. The source of power is in communication with the agitating device. The container includes an exit nozzle for dispensing the cementitious grout mixture into an opening in the ground.

### CROSS-REFERENCE TO RELATED APPLICATIONS

The present application claims priority to U.S. Provisional Patent Application Ser. No. 61/766,524, filed Feb. 19, 2013, and entitled “Portable Mixing Device for a Cementitious Grout”, which is hereby incorporated by reference as though set forth fully herein.

### TECHNICAL FIELD

The present disclosure relates generally to a mixing device for forming a grout material. More particularly, the present disclosure relates to a portable mixing device for the preparation of a cementitious grout material on site where it can be dispensed from the device to fill cracks in the ground.

### BACKGROUND OF THE INVENTION

Due, in part, to extreme weather conditions and heavy use, cracks, voids and discontinuities are known to form in concrete, asphalt and other substrates, such as roadways, sidewalks, parking lots, etc. While efforts to minimize these cracks, voids and discontinuities have been attempted, they have not been entirely successful or efficient. Additionally, the increased need for fiber optic cables and other necessary utilities has required trenches and other disturbances to be formed in existing concrete and asphalt substrates in order to install these cables and utilities below ground. There is thus a need to fill these cracks, voids, trenches, etc. that form or are formed in these asphalt and concrete substrates in order to prolong the life of the entire substrate. However, existing processes for repairing and/or filling these cracks, voids, etc. suffer from a variety of disadvantages.

Typical processes for filling these substrate cracks, voids, discontinuities, etc. involve mixing a cementitious grout off site. The fully formed grout is then transported to the site in a large mixing truck or the like for use in filling these unwanted cracks. To dispense the cementitious grout material from the truck into the cracks, a long flexible hose is typically coupled to the truck. The grout is then pumped from the stationary truck through the hose and into the crack. To allow the grout to be dispensed into the entirety of an elongated crack or void, the hose is moved so that the grout can be placed into remote portions of the crack or void without moving the truck. This process is time consuming and expensive in that it requires the grout to be mixed off site and then transported to the site for use. Additionally, the use of the hose to transfer the grout material from the truck through the hose over long distances can be problematic. This is because over these long spans, the grout can heat up significantly within the hose, which can cause it to degrade and affect its performance once input into the crack. Also, water sometimes needs to be employed to help pump the grout material through the hose over these long distances, which can decrease the quality of the grout.

It would thus be desirable to provide a crack repair process that overcomes these issues.

### SUMMARY OF THE INVENTION

It is therefore an aspect of the present disclosure to provide a portable mixing device that allows a grout material to be mixed on site where needed for immediate use.

It is another aspect of the present disclosure to provide a portable mixing device that allows a grout material to be efficiently applied as a filling material for cracks and the like.

It is still another aspect of the present disclosure to provide a portable mixing device where the grout storage receptacle is located adjacent the crack to be filled.

It is a further aspect of the present disclosure to provide a portable mixing device that can both mix and dispense grout material into a crack to be filled.

It is still another aspect of the present disclosure to provide a portable mixing device where the grout storage receptacle is located adjacent the crack to be filed.

It is yet another aspect of the present disclosure to provide a portable mixing device for a grout material that decreases the cost associated with normal crack repair processes.

It is still a further aspect of the present disclosure to provide a portable mixing device for a grout material that decreases the time required to perform crack repair in accordance with current processes.

It is still yet a further aspect of the present invention to provide a portable mixing device that helps maintain the quality of the grout material and thus improves the crack repair process.

In accordance with the above and the other aspects of the present disclosure a portable mixing device for a cementitious grout material is provided. The portable mixing device includes a base portion with a plurality of transport mechanism that allow the base portion to be easily moved along ground. The base portion includes a container disposed thereon for receiving and holding a quantity of water and a quantity of dry cementitious grout mixture. An agitating device is in communication with the container for mixing the quantity of water and the quantity of dry cementitious grout mixture to form a cementitious grout mixture. A source of power is disposed on the base portion and in communication with the agitating device. An outlet nozzle is in communication with the container for dispensing the cementitious grout mixture into an opening in the ground located adjacent the mixing device.

A method of filing an opening in ground with a cementitious grout is also provided. The method includes locating a portable mixing device at a site where an opening in the ground is to be filled with a cementitious grout. A container on the portable mixing device is filled with a quantity of water. An amount of a dry cementitious grout mixture is then provided to the container. The quantity of water and the dry cementitious grout mixture are mixed to form the cementitious grout material. The portable mixing device is then oriented adjacent the opening to be filled. A nozzle in communication with the container is then positioned so that its orifice is in communication with a portion of the opening in the ground to be filled. The cementitious grout mixture is then dispensed through the nozzle into the opening. The portable mixing device is moved along the opening as the grout material is being dispensed from the nozzle so as to fill the length of the opening.

These and other features and aspects of this disclosure will become apparent to those skilled in the art from a review of the detailed description. The drawings that accompany the detailed description are described below.

### BRIEF DESCRIPTION OF THE DRAWINGS

Other aspects of the present disclosure will be readily appreciated, as the same becomes better understood by reference to the following detailed description when considered in connection with the accompanying drawings wherein:

FIG. 1 is a perspective view of a portable grout mixing device as used to fill a crack in accordance with an aspect of the disclosure;

FIG. 2 is a perspective view of a portable grout mixing device in accordance with an aspect of the disclosure;

FIG. 3 is another perspective view of a portable grout mixing device in accordance with an aspect of the disclosure;

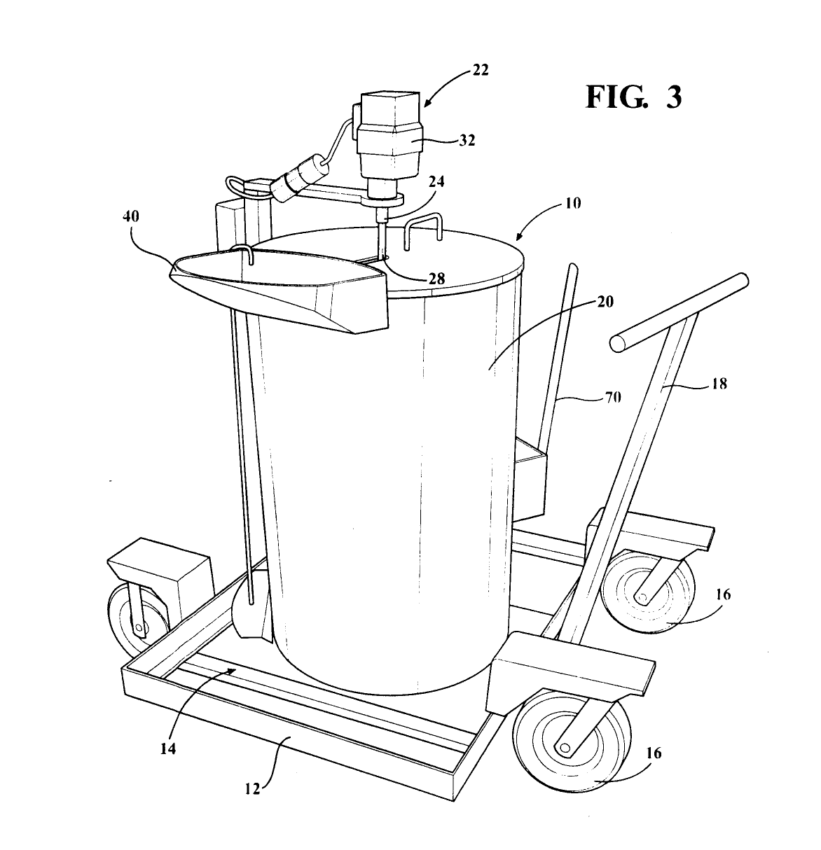

FIG. 4 is partially broken away view of the upper section of a portable grout mixing device in accordance with an aspect of the disclosure; and

FIG. 5 is a schematic illustration of a push tool being used in connection with a portable grout mixing device in accordance with an aspect of the disclosure.

### DETAILED DESCRIPTION OF THE INVENTION

As shown in the drawings, a portable mixing device 10 for forming and dispensing a cementitious grout material is provided. The portable mixing device may be configured for forming a cementitious grout material that can be used to fill openings in the ground. According to an aspect of the disclosure, the portable mixing device can be used in connection with the process of filling cracks, voids, trenches and/or other discontinuities in ground (hereinafter referred to as “openings”). The term openings is not intended to be limiting and as used herein refers to any area within ground that can be filled with a grout material. According to one aspect, these openings may be present in roadways, sidewalks or the like. Also, the roadways, sidewalks or the like may be formed of concrete or asphalt. It will be appreciated that these openings that need to be filled can be present in a variety of different substrates, which may be formed of a variety of different materials. It will be understood that the openings may form naturally due to weather exposure, fatigue from overuse, or other reasons. Additionally, the openings may be purposely formed, such as can occur when micro-trenches are created for the purpose of installing various types of underground cable.

According to an aspect, the portable mixing device 10 can be used to create a cementitious grout material for a variety of different purposes. It will also be appreciated that the portable mixing device 10 can be utilized to mix a variety of different compositions. According to a further aspect, the portable mixing device may be utilized on site where the openings to be filled are present such that the formed grout may be immediately dispensed into a crack to be filled.

With reference to the drawings, the portable mixing device 10 can include a base portion 12 having a generally flat upper surface 14. The base portion 12 is illustrated as being constructed as a generally open frame. However, the base portion 12 can take on a variety of different configurations. According to an aspect, a plurality of wheels 16 may be secured to the base portion 12 to allow the portable mixing device 10 to be easily moved or transported along the ground. Instead of wheels 16, it will be appreciated that a variety of other suitable transport structures which allow the mixing device 10 to be easily moved along ground may be employed. According to one aspect, the wheels may be rigid structures that allow the mixing device 10 to be moved in a generally straight line adjacent an opening to be filled. Alternatively, the wheels may be zero turn wheels that allow for more maneuverability of the mixing device 10.

According to an aspect, the mixing device 10 can include a handle 18 that allows a user to easily push or pull the mixing device 10 to move it along the ground. The handle 18 can be fixed or adjustable. According to an aspect, the handle 18 may be pivotally mounted to the base portion 12 such that the angle that the handle 18 extends from the base portion 12 may be varied. The base portion 12 and the handle 18 can be formed of a metal material. Alternatively, these may be formed of a variety of other suitable materials. According to one aspect, the mixing device 10 can be manually operated to move it along ground. Alternatively, the mixing device 10 may be motorized. According to this aspect, the handle 18 may be utilized for purposes of guiding the mixing device along the ground. Alternatively, the handle 18 may be removable or omitted altogether.

According to an aspect, a grout container 20 may be disposed on the upper surface 14 of the base portion 12. As discussed in more detail below, the grout container 20 may be configured to receive the components of a cementitious grout material to be mixed and then formed. For example, a predetermined quantity of water may be provided to the grout container 20. A dry grout mixture or composition may then be input into the grout container 20 for mixing with water placed therein. The order of placement of the materials into the container can obviously vary. According to an aspect, a preferred dry grout mixture is available from SuperGrout Products, LLC of Saginaw, Mich. under the name “GeoSuperGrout” or “MicroTrench SuperGrout”. It will be appreciated that a variety of other dry grout mixtures may be utilized. An exemplary dry grout composition is disclosed in Applicant's co-pending patent application Ser. No. 12/885,100, entitled “Grout for Filing a Micro-trench”, filed Sep. 17, 2010, which is hereby incorporated by reference as though set forth fully herein. It will also be appreciated that a variety of other grout materials having different compositions may be mixed and formed and employed with the device 10. The grout container 20 may be formed of a metal material, but may alternatively be formed of other suitable materials, such as plastic. As shown, the grout container 20 may be configured as a cylinder. However, the container 20 may have a variety of different shapes and sizes.

According to an aspect, an agitating mechanism 22 may be in communication with the grout container 20 to agitate or stir the quantity of water and the dry grout mixture therein to form the final grout mixture or otherwise keep it mixed. As shown, the agitating mechanism 22 may include an upper portion 24 disposed above an open end 26 of the grout container 20 and a rotating stem portion 28 that extends into the interior 30 of the grout container 20. The rotating stem portion 28 may be configured as an auger to assist with mixing the dry grout and water to form the final mixed cementitious grout. However, the stem portion may have a variety of other suitable configurations for mixing the contents of the grout container 20. The upper portion 24 of the stem portion 28 may be in communication with a drive mechanism 32 such as a motor to cause the rotating stem mechanism 28 to rotate. Alternatively, the agitating mechanism could be operated manually. According to an aspect, the drive mechanism 32 may be in communication with a power source 34. The power source 34 may be portable and can operate without being connected to a source of electricity. According to another aspect, the power source 34 may be gas powered. However, the power source 34 may be battery powered or powered by other suitable self-contained means. Actuation of the power source 34 can be controlled by an on/off switch 36. An electrical outlet 38 may also be disposed adjacent the on/off switch 36 to facilitate attachment of other devices requiring power.

According to another aspect, a support tray 40 may be disposed adjacent the open upper end 26 of the grout container 20. The support tray 40 can be configured to allow a bag of dry grout mixture to be disposed thereon. The support tray 40 may be configured such that its bottom includes an opening 42 that allows the dry grout mixture to be poured therethrough directly into the interior 30 of the grout container 20.

According to an aspect, the grout container 20 may include an outlet opening 46 disposed adjacent a lower portion 48 of the container 20. According to an aspect, an exit nozzle 50 may be placed in communication with the outlet opening 46 to allow the grout mixture to be controllably emitted from the grout container 20 into an opening in ground to be filled, as generally designated by reference number 100. The exit nozzle 50 may be formed of a metal material and may terminate in an outlet orifice 52. According to an aspect, the exit nozzle 52 may be elongated at its end to allow for better communication with the opening 100 to be filled with grout material. Put another way, the exit nozzle 52 may be generally configured to match a shape of an opening to allow for efficient dispensing of material directly into the opening 100.

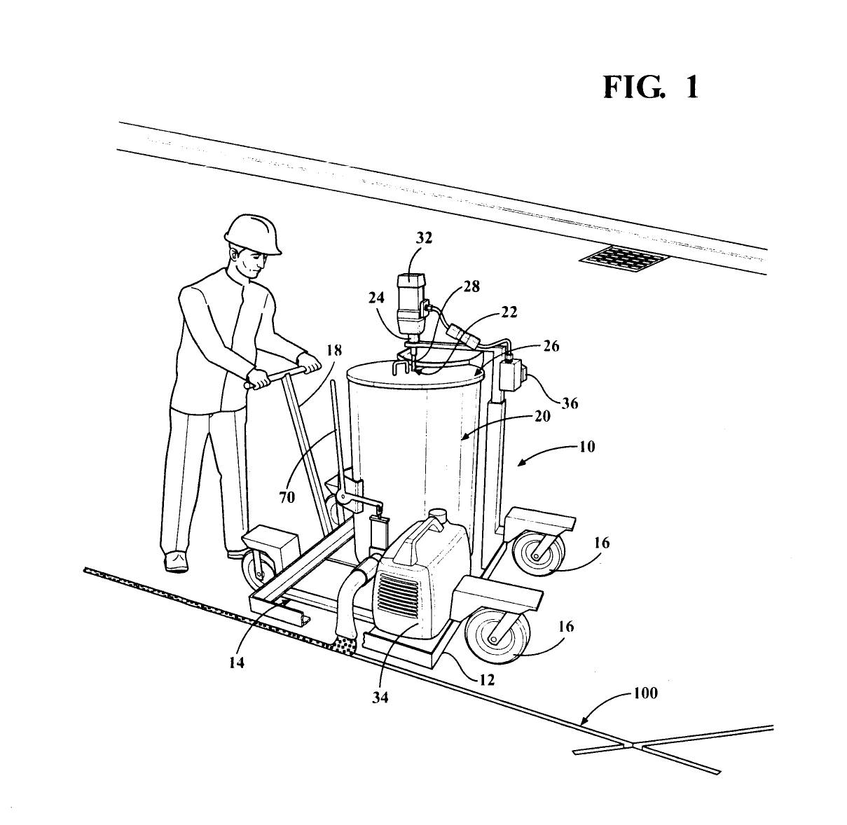

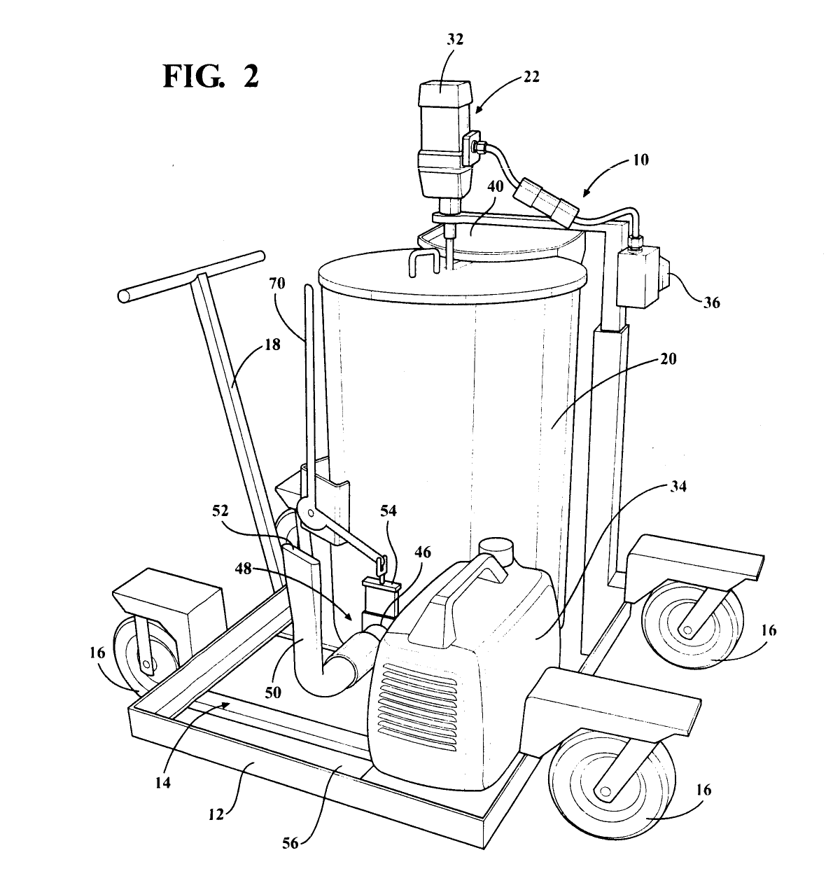

According to an aspect, the exit nozzle 52 may be attached to the outlet 46 by a coupling that allows the exit nozzle 50 to rotate between a position facing upward (away from ground) (FIG. 2) and a downward position where it may be disposed within or adjacent an opening 100 to dispense the grout material thereto (FIG. 1). The exit nozzle 50 could be configured to rotate to other positions. According to another aspect, a shut off device 54, such as a gate valve, may be disposed adjacent the outlet 46 such that the flow of the grout mixture from the interior 30 of the container 20 to the exit nozzle 50 may be controlled and shut off. According to an aspect, the valve 50 may be manually controlled by a lever 70. Alternatively, the valve 50 may be hydraulically controlled, pneumatically controlled or controlled by other suitable power source. It will be understood that the exit nozzle 50 and the outlet orifice 52 may take on a variety of different configurations and can be formed of a variety of different materials. Additionally, a variety of different types of devices for controlling the flow of grout material may be employed.

According to an aspect, the nozzle portion 50 may extend from the grout container 20 only a short distance such that the outlet orifice 52 may be located adjacent the grout container 20 and/or the mixing device 10. According to another aspect, the base portion 12 may be configured as an open frame and the exit nozzle 52 may be configured to extend downward through a space 56 in the base portion 12 such that the grout is emitted through an opening in the base portion 12. Put another way, the exit nozzle 52 may reside within the outer boundary of the base portion 12 during operation. This provides increased protection for the exit nozzle 52 and minimizes the possibility of damage resulting from contact with other structures as the mixing device 10 is transported or operated.

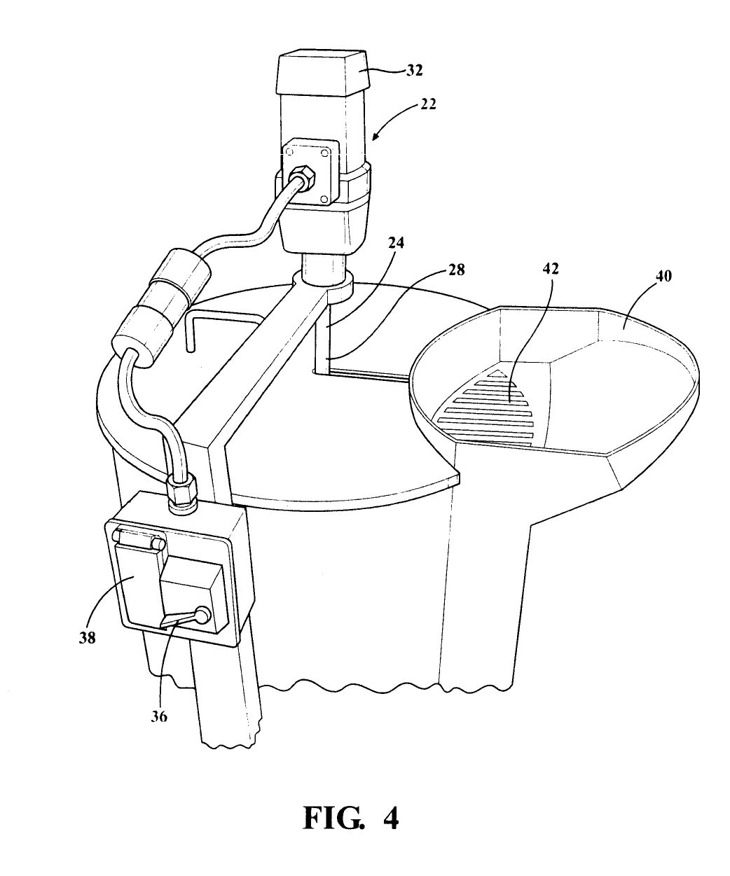

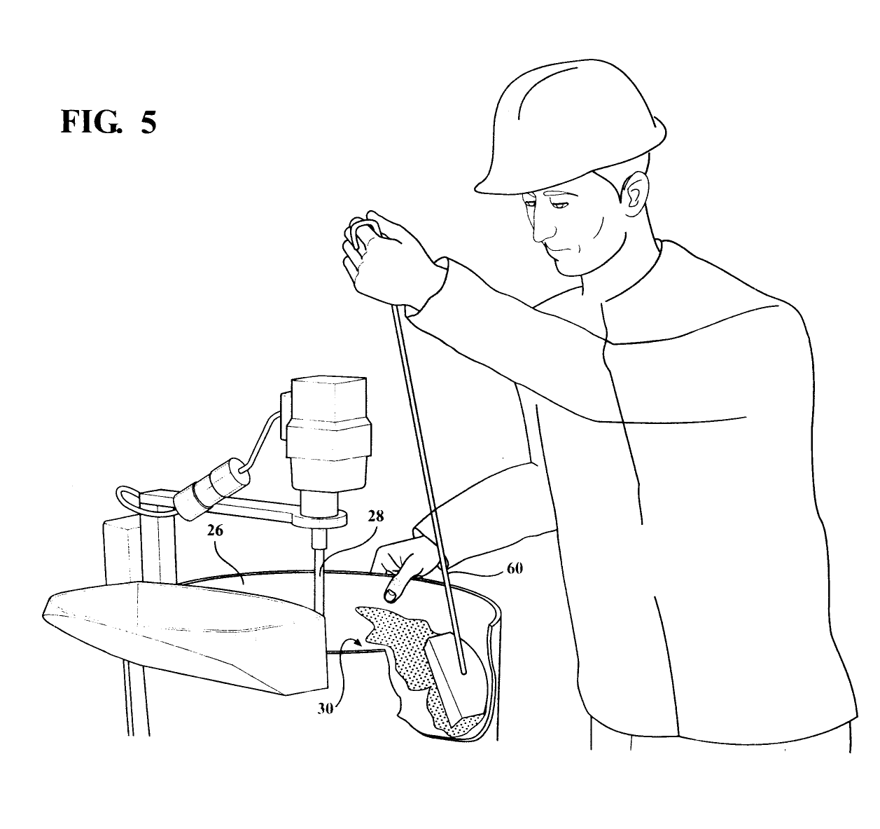

According to an exemplary aspect, the portable mixing device 10 can be used as part of a process for filing openings in ground, such as for micro-trenching operations or for fixing an existing crack in a roadway. Pursuant to this example, the portable mixing device 10 may be located on site where the opening to be filled is located. Once the opening is ready to be filled, a quantity of water can be poured into the grout container 20. Then a bag of dry grout mixture may be poured through the opening 42 in the support tray 40 into the container 20 (FIG. 4). It will be appreciated that the dry grout material could also be poured directly into the open upper end of the grout container 20. As the dry grout material is being poured into the grout container 20, the agitating mechanism 22 may be switched on to help stir contents in the grout container 20 and form the grout mixture. To activate the agitating mechanism 22, the drive mechanism 32 may be activated by actuating the switch 36. Additionally, as shown in FIG. 5, a push down device 60 can be utilized to push down any dry grout on the walls of the container 20 to ensure that a complete mixture of materials occurs.

Once the grout material is formed, the portable mixing device 10 can be positioned adjacent the opening 100 in ground to be filled. According to an aspect, the wheels 16 adjacent the exit nozzle 50 may be oriented next to the crack 100. When the mixing device 10 is oriented next to the crack, the crack can be seen though the space 54 in the base portion 12. Thereafter, the exit nozzle 50 can be rotated such that the outlet orifice 52 is disposed in or adjacent the crack. The shut off device 54 may then be opened to allow the grout material to flow from the container 20 and pass directly into the crack. As the grout material is flowing out the exit nozzle 50 into the crack, the portable mixing device 10 can be moved along the side of crack to allow length of the crack to be filled. It will be appreciated that the method may have more or less steps as needed.

Note that not all of the activities described above in the general description or the examples are required, that a portion of a specific activity may not be required, and that one or more further activities may be performed in addition to those described. Still further, the order in which activities are listed are not necessarily the order in which they are performed.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Many other embodiments may be apparent to those of skill in the art upon reviewing the disclosure. Other embodiments may be used and derived from the disclosure, such that a structural substitution, logical substitution, or another change may be made without departing from the scope of the disclosure. Accordingly, the disclosure is to be regarded as illustrative rather than restrictive.

Certain features are, for clarity, described herein in the context of separate embodiments, may also be provided in combination in a single embodiment. Conversely, various features that are, for brevity, described in the context of a single embodiment, may also be provided separately or in any sub combination. Further, reference to values stated in ranges includes each and every value within that range.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

Although only a few exemplary embodiments have been described in detail above, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. A portable mixing device for cementitious grout, comprising:
a base portion;
a transport mechanism secured to the base portion;
a container disposed on the base portion, the container configured to receive a quantity of water and a quantity of dry cementitious grout mixture;
an agitating device in communication with an interior of the container for mixing the quantity of water and the quantity of dry cementitious grout mixture to form a cementitious grout mixture;
a portable source of power disposed on the base portion and in communication with the agitating device; and
an exit nozzle in communication with the container for dispensing the cementitious grout mixture into an opening in the ground, the exit nozzle having an outlet orifice disposed adjacent the base portion.

2. The portable mixing device of claim 1, wherein the transport mechanism includes a plurality of wheels rotatably secured to the base portion to allow the mixing device to be moved along ground.

3. The portable mixing device of claim 1, wherein the agitating device includes an auger portion disposed in the interior of the container for mixing the quantity of water and the quantity of dry cementitious grout.

4. The portable mixing device of claim 1, wherein the outlet orifice is elongated and configured to engage a crack in the ground.

5. The portable mixing device of claim 1, further comprising:
a valve disposed between the container and the exit nozzle, the valve being moveable between an open position that allows the cementitious grout mixture to flow from the container to the outlet orifice and a closed position that prevents the flow of the cementitious grout mixture from the container to the outlet orifice.

6. The portable mixing device of claim 1, further comprising:
a tray disposed adjacent an upper portion of the container for supporting a bag of dry cementitious grout material.

7. The portable mixing device of claim 1, wherein the exit nozzle is rotatable between a first position where the outlet orifice is disposed adjacent a crack in the ground to be filled and a second position where the outlet orifice is oriented away from the crack.

8. The portable mixing device of claim 1, further comprising:
a handle in communication with the base portion to allow the device to be manually propelled.

9. The portable mixing device of claim 1, wherein the source of power is selected from one of the following: a gas powered motor and an electric motor.

10. The portable mixing device of claim 1, wherein the base portion includes an opening that is configured to receive the exit nozzle therethrough when oriented to dispense grout material into the opening to be filled.

11. A method of filing an opening in ground with a cementitious grout, comprising:
providing a portable mixing device which may be located adjacent an opening in the ground to be filled with a cementitious grout material;
providing a container on the portable mixing device for receiving a quantity of water;
adding a predetermined amount of a dry cementitious grout mixture;
mixing the quantity of water and the dry cementitious grout mixture to form the cementitious grout material;
positioning a rigid nozzle that is in communication the container adjacent a portion of the opening in the ground to be filled;
dispensing the cementitious grout material through the nozzle into the opening; and
moving the portable mixing device along the elongated opening as the cementitious grout material is being dispensed so as to fill the length of the elongated opening.

12. The method of claim 11, wherein the step of mixing can be accomplished by an augur device.

13. The method of claim 12, further comprising:
disposing a portable power source on the mixing device and placing it in communication with the augur device to accomplish the step of mixing.

14. The method of claim 11, wherein the step of moving the portable mixing device occurs manually.

15. The method of claim 11, further comprising:
positioning the rigid nozzle through a gap in the mixing device such that mixing device at least partially overlies the opening as the cementitious grout is placed therein.

16. The method of claim 11, further comprising:
rotating the nozzle between a dispensing position where an outlet orifice is disposed adjacent the opening and a retracted position where the outlet orifice is removed from communication with the opening.

17. A portable mixing device for a cementitious grout, comprising:
an open frame portion, the open frame having a footprint defined by its perimeter;
a plurality of wheels rotateably secured to the frame portion;
a container disposed on the frame portion, the container configured to receive a quantity of water and a quantity of dry cementitious grout mixture;
an agitating device in communication with an interior of the container for mixing the quantity of water and the quantity of dry cementitious grout mixture to form a cementitious grout mixture;
an exit nozzle in communication with the container for dispensing the cementitious grout mixture into an opening in the ground, the exit nozzle being configured to extend through an opening in the open frame and into communication with an opening in the ground to be filled, wherein the nozzle is configured to emit cementitious grout into the opening from within the footprint of the device.

18. The device of claim 17, further comprising:
a portable source of power disposed on the frame portion and in communication with the agitating device.

19. The portable mixing device of claim 17, further comprising:
a valve disposed between the container and the exit nozzle, the valve being moveable between an open position that allows the cementitious grout mixture to flow from the container to an outlet orifice and a closed position that prevents the flow of the cementitious grout mixture from the container to the outlet orifice.

20. The portable mixing device of claim 17, wherein the exit nozzle is rotatable between a first position where the outlet orifice is disposed adjacent a crack in the ground to be filled and a second position where the outlet orifice is oriented away from the crack.
